(19) United States
(12) Patent Application Publication
(10) Pub. No.: US 2005/0190993 A1
(43) Pub. Date: Sep. 1, 2005

(54) Method and apparatus for determining an edge trend for an interested pixel of an image

(76) Inventor: Yin-Bin Chang, Taipei City (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 11/060,536

(22) Filed: Feb. 18, 2005

(30) Foreign Application Priority Data
Feb. 23, 2004 (TW) 093104479

(51) Int. Cl. G06K 9/32; G06K 9/48

(52) U.S. Cl. 382/300; 382/199

(57) ABSTRACT

In a method and apparatus for determining an edge trend for an interested pixel of an image, a plurality of selected pixels nearby the interested pixel are evaluated to obtain a dominant image direction thereof, and thereby to further obtain the edge trend from the dominant image direction. Each of the selected pixels is evaluated from a plurality of corresponding color values to determine an image direction, and the dominant image direction is the image direction that the most of the selected pixels are determined to have.

### FIELD OF THE INVENTION

The present invention is related generally to an image processing method and apparatus, and more particularly, to a method and apparatus for determining an edge trend for an interested pixel of an image.

### BACKGROUND OF THE INVENTION

A color image can be obtained by a single sensor array that has each of the pixel locations in the array to sense a single color to thereby generate a color value, in association with a color filter array interpolation (CFAI) to generate the missing color values for each pixel location thereof from the color values of several selected pixels corresponding thereto to thereby reconstruct a full color image. By using the image sensor to generate a specific pattern of color values with each pixel location thereof generating one color value, processes for performing CFAI to obtain the missing color values become easier and more efficient. In a Bayer pattern for example, the dominant color of an image is sensed by the intersected pixel locations in the array of a CFAI sensor, and the other pixel locations in the array are arranged to sense the other two colors. This technique is currently utilized in the single senor camera, in which the senor is coated with a color filter array thereon, and the color filter array has a certain pattern such that each pixel location of the sensor will generate a signal corresponding to only one color among red, green and blue colors to represent the color value for that color. In other words, the original image generated by the sensor still contains red, green and blue colors, while each pixel of the image only has one color value corresponding to red, green or blue color. In order to reconstruct a full color image from the original image, a conventional CFAI transforms the original image to another with each pixel thereof to have three color values representative of red, green and blue colors respectively, and the missing color values of each interested pixel are interpolated from the color values of the selected pixels nearby the interested pixel. Therefore, the employed algorithm for the CFAI process will determine the image quality of the reconstructed full color image.

Bilinear interpolation is a simple and direct CFAI method, by which the color values of several pixels nearby an interested pixel are averaged for serving as the missing color values of the interested pixel. However, this non-edge based CFAI will generate artifacts at the edge of the color image, causing resolution loss. Edge based CFAI could reduce the artifacts at the edge of the color image and thereby improve the sharpness of the reconstructed image. An edge based CFAI evaluates the interested pixel to determine an edge trend thereof, for example in either a horizontal image direction or a vertical image direction, and selects the color values of several pixels nearby the interested pixel in the determined image direction to interpolate the missing color values for the interested pixel. It is therefore obvious that the judgment of the edge trend for the interested pixel will determine how better of image quality will be produced from the interpolated color values. The edge trend of an image can be determined by the gradient values between the color values of several selected pixels nearby an interested pixel. FIG. 1 shows a 6×6 pixel array 10 where the symbols R, G and B represent the color values of red, green and blue colors respectively, and the lower index numbers stand for the coordinates of each pixel in the array 10. The color value in the parentheses is generated by interpolation from the actual color values of several selected pixels. For example, the pixel (4,3) has the blue value B₄₃ originally, and the green value G₄₃ in the parentheses is interpolated from the color values of several selected pixels nearby the pixel (4,3). To interpolate G₄₃, in a conventional CFAI, the horizontal and vertical gradient values between the color values of several selected pixels are obtained in advance by
ΔH=|G₄₂−G₄₄|+|B₄₃−B₄₁+B₄₃−B₄₅|+|G₃₃−G₃₂+G₃₃−G₃₄| [Eq-1]
and
ΔV=|G₃₃−G₅₃|+|B₄₃−B₂₃+B₄₃−B₆₃ |+|G₃₂−G₄₂−G₃₄−G₄₄|, [Eq-2]
and then, if ΔH<ΔV, the edge trend for the pixel (4,3) is considered to be along the horizontal image direction, and thereby the color values of several selected pixels in the horizontal image direction are used to interpolate G₄₃, for example by
G₄₃=(G₄₂+G₄₄)÷2; [Eq-3]
otherwise, if ΔH>ΔV, the edge trend for the pixel (4,3) is considered to be along the vertical image direction, and thereby the color values of several selected pixels in the vertical image direction are used to interpolate G₄₃, for example by
G₄₃=(G₃₃+G₅₃)÷2. [Eq-4]
This method is simple and efficient when the edge trend is much strong. However, undesired result may be conducted when the horizontal gradient value ΔH and the vertical gradient value ΔV are close to each other, especially in a noisy condition, due to the edge trend easily to be misjudged. Another weakness of this method is that cross often occurs in the reconstructed image, for example on the nose of a human face.

Therefore, it is desired an improved method and apparatus for determining an edge trend for an interested pixel of an image.

### SUMMARY OF THE INVENTION

One object of the present invention is to provide a method and apparatus for determining an edge trend for an interested pixel of an image by evaluating several pixels nearby the interested pixel.

Another object of the present invention is to provide a method and apparatus for correctly determining an edge trend for an interested pixel of an image even when the horizontal and vertical gradient values corresponding to the interested pixel are close to each other.

In a method for determining an edge trend for an interested pixel of an image, according to the present invention, a plurality of selected pixels nearby the interested pixel are evaluated to obtain a dominant image direction thereof, and then the edge trend is obtained from the dominant image direction. In one embodiment, each of the selected pixels is evaluated from a plurality of color values corresponding thereto to determine an image direction, and the dominant image direction is the image direction that is determined for the most of the selected pixels. To determine the image direction for one of the selected pixels, in one embodiment, two gradient values are obtained from a plurality of color values in two image directions for that selected pixel, and the image direction is determined to be either one of the two image directions or none by the sign of the product of the two gradient values. To obtain the dominant image direction, in one embodiment, the pixel numbers corresponding to each of the image directions are obtained by counting the selected pixels having that respective image direction, and the image direction corresponding to the maximum of the pixel numbers is determined to be the dominant image direction. If the pixel number of the selected pixels having the first of the two image directions is larger than the pixel number of the selected pixels having the second of the two image directions, it is determined the edge trend for the interested pixel to be along the first direction. If the pixel number of the selected pixels having the first image direction is smaller than the pixel number of the selected pixels having the second image direction, it is determined the edge trend for the interested pixel to be along the second direction.

To perform the method, an apparatus comprises a buffer to store the color values of the selected pixels, and a processor to evaluate the selected pixels to obtain the dominant image direction, and to further obtain the edge trend from the dominant image direction. In one embodiment, the processor reads out the color values from the buffer, determines the image directions for the selected pixels from the color values, and determines the dominant image direction to be that image direction corresponding to the most of the selected pixels. In one embodiment, for each of the selected pixel, the processor calculates two gradient values from a plurality of color values in two image directions corresponding to that selected pixel, and determines the image direction for that selected pixel to be either one of the two image directions or none by the sign of the product of the two gradient values. In one embodiment, the processor counts the selected pixels to obtain the pixel numbers corresponding to each of the image directions, and to further obtain the maximum of the pixel numbers to thereby determine the dominant image direction.

### BRIEF DESCRIPTION OF DRAWINGS

These and other objects, features and advantages of the present invention will become apparent to those skilled in the art upon consideration of the following description of the preferred embodiments of the present invention taken in conjunction with the accompanying drawings, in which:

FIG. 1 shows the original color values of a 6×6 pixel array;

FIG. 2 shows the green values of a 5×5 pixel array with the pixel (3,3) as the center that is to be interpolated to generate the missing green value G₃₃;

FIG. 3A shows the green values of a 3×3 pixel array with the pixel (2,3) as the center to illustrate the determination of an image direction for the pixel (2,3);

FIG. 3B shows the green values of a 3×3 pixel array with the pixel (3,2) as the center to illustrate the determination of an image direction for the pixel (3,2);

FIG. 3C shows the green values of a 3×3 pixel array with the pixel (3,4) as the center to illustrate the determination of an image direction for the pixel (3,4);

FIG. 3D shows the green values of a 3×3 pixel array with the pixel (4,3) as the center to illustrate the determination of an image direction for the pixel (4,3);

FIG. 4 shows an apparatus to perform the interpolation of the missing green value G₃₃; and

FIG. 5 shows a flow chart to perform the interpolation of the missing green value G₃₃.

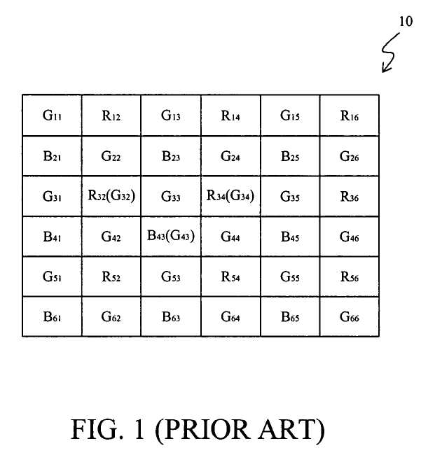

### DETAILED DESCRIPTION OF THE INVENTION

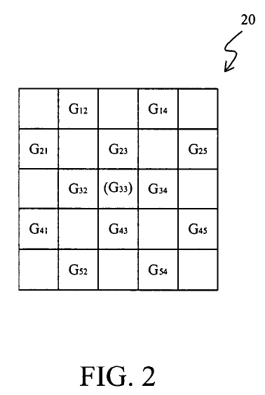

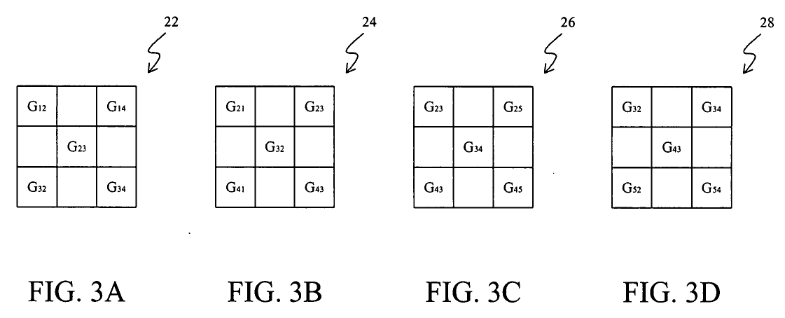

The method of the present invention comprises evaluating a plurality of pixels nearby an interested pixel of an image to obtain a dominant image direction thereof, and obtaining an edge trend from the dominant image direction for the interested pixel. FIG. 2 shows the green values of a 5×5 pixel array 20, in which the green value G₃₃ of the center pixel (3,3) is to be interpolated, and the other green values Gy are the original ones generated by an image sensor and are used to determine the edge trend for the interested pixel (3,3). First of all, the pixels (2,3), (3,2), (3,4) and (4,3) nearby the interested pixel (3,3) are selected to be evaluated to obtain the dominant image direction thereof, for example in a horizontal image direction or in a vertical image direction. In order to make it easier to understand, the related green values with each of the pixels (2,3), (3,2), (3,4) and (4,3) as the center are separately shown in FIGS. 3A, 3B, 3C and 3D to determine their image directions. Namely, FIG. 3A shows the green values of a 3×3 pixel array 22 with the pixel (2,3) as the center, FIG. 3B shows the green values of a 3×3 pixel array 24 with the pixel (3,2) as the center, FIG. 3C shows the green values of a 3×3 pixel array 26 with the pixel (3,4) as the center, and FIG. 3D shows the green values of a 3×3 pixel array 28 with the pixel (4,3) as the center.

In FIG. 3A, to determine the image direction for the pixel (2,3), the gradient value between the green values G₁₂ and G₃₄ of the diagonal pixels (1,2) and (3,4) is obtained by
Δ₁=G₁₂−G₃₄, [Eq-5]
and the gradient value between the green values G₁₄ and G₃₂ of the pixels (1,4) and (3,2) in the other diagonal direction is obtained by
Δ₂=G₁₄−G₃₂. [Eq-6]
Multiplication of these two gradient values Δ₁ and Δ₂ results in
Buffer₁=(G₁₂−G₃₄)×(G₁₄−G₃₂), [Eq-7]
when Buffer₁>0, the pixel (2,3) has a horizontal image direction, and
when Buffer₁<0, the pixel (2,3) has a vertical image direction.
   In other words, the sign of the product Buffer₁ of the gradients Δ₁ and Δ₂ of the green values G₁₂, G₃₄, G₁₄ and G₃₂ in the two diagonal image directions of the pixel (2,3) could be used to determine the image direction for the pixel (2,3).

Likewise, In FIG. 3B, to determine the image direction for the pixel (3,2), the gradient values between the green values G₂₁ and G₄₃ and between the green values G₂₃ and G₄₁ are calculated in advance, and then the product of the gradient values is calculated by
Buffer₂=(G₂₁−G₄₃)×(G₂₃−G₄₁), [Eq-8]
when Buffer₂>0, the pixel (3,2) has a horizontal image direction, and
when Buffer₂<0, the pixel (3,2) has a vertical image direction.
   By the same manner, from FIG. 3C and FIG. 3D, the other two products of the respective gradient values are obtained by
   Buffer₃=(G₂₃−G₄₅)×(G₂₅−G₄₃), [Eq-9]
when Buffer₃>0, the pixel (3,4) has a horizontal image direction, and
when Buffer₃<0, the pixel (3,4) has a vertical image direction, and
   Buffer₄=(G₃₂−G₅₄)×(G₃₄−G₅₂), [Eq-10]
when Buffer₄>0, the pixel (4,3) has a horizontal image direction, and
when Buffer₄<0, the pixel (4,3) has a vertical image direction.

After evaluating the pixels (2,3), (3,2), (3,4) and (4,3) nearby the interested pixel (3,3) to determine their image directions, the pixel numbers S_{I} and S_{V} of those among the pixels (2,3), (3,2), (3,4) and (4,3) having horizontal and vertical image directions are counted. If the pixel number S_{I} of the pixels having the horizontal image direction is larger than the pixel number S_{V} of the pixels having the vertical image direction, it is determined the edge trend to be along the horizontal image direction for the interested pixel (3,3). Contrarily, if the pixel number S_{I} of the pixels having the horizontal image direction is smaller than the pixel number S_{V} of the pixels having the vertical image direction, it is determined the edge trend to be along the vertical image direction for the interested pixel (3,3). If the pixel numbers S_{I} and S_{V} are equal, it is determined no edge trend for the interested pixel (3,3), and bilinear interpolation is employed to interpolate the green value G₃₃ for the pixel (3,3), for example by averaging the green values of G₂₃, G₃₂, G₃₄ and G₄₃.

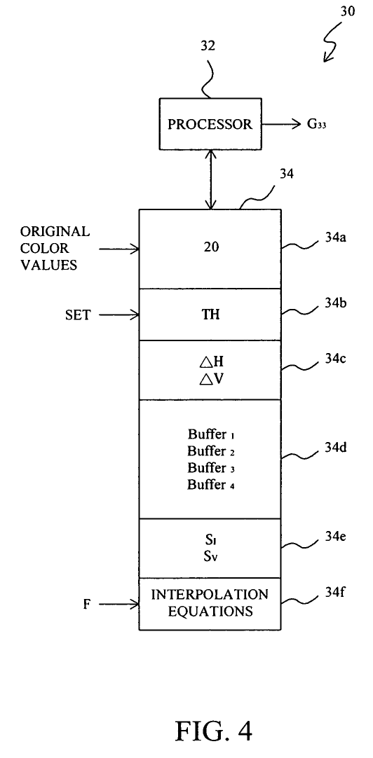

To carry out the above method and interpolation for the pixel (3,3), FIG. 4 shows an apparatus 30 that comprises a processor 32 and a buffer 34. The original color values, for example those shown by FIG. 2 in the array 20 with the pixel (3,3) as the center, are stored in a segment 34a of the buffer 34 at first, and then the aforementioned method is performed. In particular, the processor 32 reads out the green values in the array 20 from the segment 34a, calculates the gradient values between the respective green values and the products' of the corresponding gradient values for those selected pixels (2,3), (3,2), (3,4) and (4,3) nearby the interested pixel (3,3) by the equations Eq-5 to Eq-10 for example, and obtains the pixel numbers S_{I} and S_{V} by counting among the selected pixels (2,3), (3,2), (3,4) and (4,3) that have horizontal and vertical image directions to further obtain the dominant image direction for determining the edge trend for the interested pixel (3,3). In order to reduce the operations of the apparatus 30, in one embodiment, the buffer 34 further stores a threshold TH determined by an input SET in a segment 34b, and the processor 32 reads out the original values in the array 20 from the segment 34a of the buffer 34, calculates the horizontal gradient value ΔH and the vertical gradient value ΔV from the corresponding color values for the interested pixel (3,3) to store in a segment 34c of the buffer 34, and compares the difference between the horizontal gradient value ΔH and the vertical gradient value ΔV, i.e., |ΔH−ΔV|, with the threshold TH. If |ΔH−Δ|≧TH, a conventional method is used to determine an edge trend for the interested pixel (3,3). In contrast, if |ΔH−ΔV|<TH, the operations for example of the equations Eq-7 to Eq-10 are performed to determine the edge trend for the interested pixel (3,3), as illustrated in the aforementioned embodiments. In the circumstances of |ΔH−ΔV |<TH, the processor 32 reads out the color values from the segment 34a of the buffer 34 and carries out the calculations for example of the equations Eq-7 to Eq-10 to generate Buffer₁ to Buffer₄ to store in a segment 34d of the buffer 34. The pixel number S_{I} of the selected pixels having the horizontal image direction and the pixel number S_{V} of the selected pixels having the vertical image direction corresponding to the Buffer₁ to Buffer₄ are obtained by counting among the selected pixels (2,3), (3,2), (3,4) and (4,3) and stored in a segment 34e of the buffer 34. The pixel numbers S_{I} and S_{V} are further compared with each other to determine the edge trend for the interested pixel (3,3). Then the missing green value G₃₃ is interpolated according to the interpolation equations stored in a segment 34f of the buffer 34, for example
when S_{I}>S_{V}, G₃₃=(G₃₂+G₃₄)÷2, [Eq-11]
when S_{I}<S_{V}, G₃₃=(G₂₃+G₄₃)+2, and [Eq-12]
when S_{I}=S_{V}, G₃₃=(G₂₃+G₃₂+G₃₄+G₄₃)÷4. [Eq-13]
The interpolation equations stored in the segment 34f of the buffer 34 can be determined by an input F. These interpolation equations can employ conventional CFAI methods or their improvements. In other embodiments, the processor 32 does not calculate ΔH and ΔV and compare the difference |ΔH−ΔV | with TH, and instead, the equations Eq-7 to Eq-10 are used to calculate Buffer₁ to Buffer₄ directly, i.e., it is completely determined by the horizontal and vertical image directions of the selected pixels (2,3), (3,2), (3,4) and (4,3) nearby the interested pixel (3,3) for the edge trend for the interested pixel (3,3).

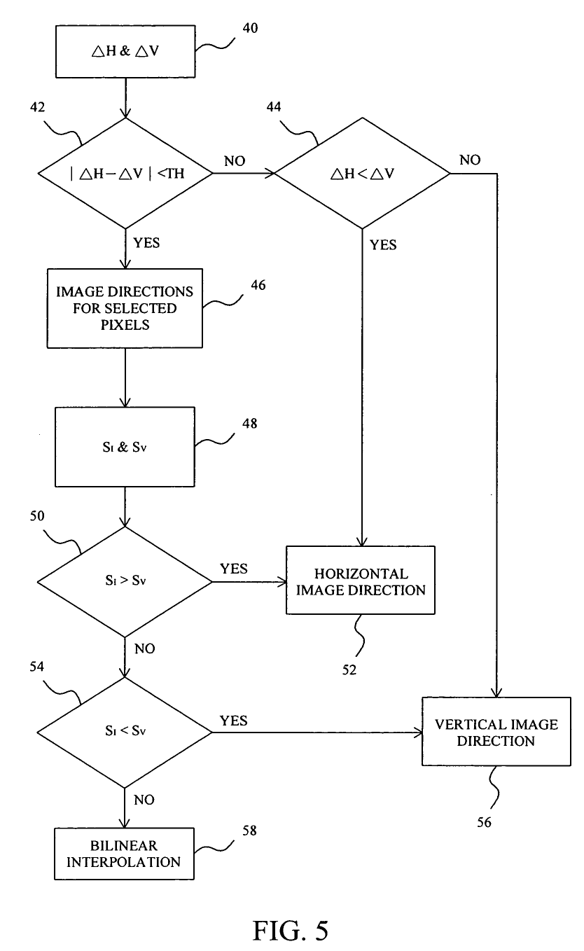

FIG. 5 shows a flow chart to perform the above method and interpolation of the missing green value G₃₃ for the pixel (3,3). To determine the edge trend for the interested pixel (3,3) shown in FIG. 2, in step 40, the processor 32 calculates the horizontal gradient value ΔH and the vertical gradient value ΔV from the corresponding color values for the interested pixel (3,3) by the equations Eq-1 and Eq-2 or simpler equations, for example
ΔH=|G₃₄−G₃₂| [Eq-14]
and
ΔV=|G₄₃−G₂₃. [Eq-15]
Step 42 determines whether the difference |ΔH−ΔV | is smaller than the threshold TH. If it is not, step 44 is performed to further compare the horizontal gradient value ΔH and the vertical gradient value ΔV. If ΔH<ΔV, it is determined the edge trend to be the horizontal image direction for the interested pixel (3,3), and it goes to step 52 subsequently to interpolate G₃₃ by the corresponding equation, for example the equation Eq-11. If ΔH>ΔV in step 44, it is determined the edge trend to be the vertical image direction for the interested pixel (3,3), and it goes to step 56 subsequently to interpolate G₃₃ by the corresponding equation, for example the equation Eq-12. If |ΔH−ΔV|<TH is obtained in step 42, step 46 is then proceeded, and the equations Eq-7 to Eq-10 are carried out to determine the image directions for the selected pixels (2,3), (3,2), (3,4) and (4,3) nearby the interested pixel (3,3). In step 48, the pixel numbers S_{I} and S_{V} of those having the horizontal and vertical image directions are obtained by counting among the selected pixels (2,3), (3,2), (3,4) and (4,3) nearby the interested pixel (3,3). Steps 50 and 54 are performed to compare S_{I} with S_{V}, to determine the dominant image direction among the selected pixels (2,3), (3,2), (3,4) and (4,3) and to further determine the edge trend for the interested pixel (3,3) from the dominant image direction. When the pixel number S_{I} of the selected pixels having the horizontal image direction is larger than the pixel number S_{V} of the selected pixels having the vertical image direction, it is determined the edge trend to be the horizontal image direction for the interested pixel (3,3), and it goes to step 52 to interpolate G₃₃ by the corresponding equation, for example the equation Eq-11. Contrarily, when the pixel number S_{I} of the selected pixels having the horizontal image direction is smaller than the pixel number S_{V} of the selected pixels having the vertical image direction, it is determined the edge trend to be the vertical image direction for the interested pixel (3,3), and it goes to step 56 to interpolate G₃₃ by the corresponding equation, for example the equation Eq-12. If the pixel numbers S_{I} and S_{V} are equal, it goes to step 58 to generate G₃₃ by a bilinear interpolation, for example the equation Eq-13. In other embodiments, without carrying out steps 40 to 44, it starts from step 46 to determine the edge trend for the interested pixel (3,3) solely by the pixel numbers S_{I} and S_{V}.

From the exemplary method and apparatus, even in the situations that the horizontal and vertical gradient values at an interested pixel are close to each other, it is still capable of correctly determining the edge trend for the interested pixel.

While the present invention has been described in conjunction with preferred embodiments thereof, it is evident that many alternatives, modifications and variations will be apparent to those skilled in the art. Accordingly, it is intended to embrace all such alternatives, modifications and variations that fall within the spirit and scope thereof as set forth in the appended claims.

1. A method for determining an edge trend for an interested pixel of an image, comprising the steps of:
evaluating a plurality of selected pixels nearby the interested pixel for obtaining a dominant image direction thereof; and
obtaining the edge trend from the dominant image direction.

2. The method of claim 1, wherein the step of evaluating a plurality of selected pixels nearby the interested pixel for obtaining a dominant image direction thereof comprises the steps of:
determining an image direction for each of the plurality of selected pixels;
obtaining a pixel number for each of the plurality of image directions by counting the plurality of selected pixels; and
determining the dominant image direction as the one of the plurality of image directions corresponding to the maximum of the plurality of pixel numbers.

3. The method of claim 2, wherein the plurality of image directions comprises a horizontal image direction and a vertical image direction.

4. The method of claim 2, wherein the step of determining an image direction for each of the plurality of selected pixels comprises the steps of:
obtaining two gradient values from a plurality of corresponding color values in two image directions for each of the plurality of selected pixels; and
determining the image direction as either one of the two image directions or none by the sign of the product of the two gradient values for each of the plurality of selected pixels.

5. The method of claim 4, wherein the two image directions are orthogonal to each other.

6. The method of claim 4, wherein the two image directions are two diagonal image directions.

7. An apparatus for determining an edge trend for an interested pixel of an image, comprising:
a buffer for storing a plurality of color values of a plurality of selected pixels nearby the interested pixel; and
a processor for evaluating the plurality of selected pixels for obtaining a dominant image direction thereof, and obtaining the edge trend from the dominant image direction.

8. The apparatus of claim 7, wherein the processor determines an image direction for each of the plurality of selected pixels, obtains a pixel number for each of the plurality of image directions by counting the plurality of selected pixels, and determines the dominant image direction as the one of the plurality of image directions corresponding to the maximum of the plurality of pixel numbers.

9. The apparatus of claim 8, wherein the plurality of image directions comprises a horizontal image direction or a vertical image direction.

10. The apparatus of claim 8, wherein the processor obtains two gradient values from a plurality of corresponding color values among the plurality of color values in two image directions for each of the plurality of selected pixels, and determines the image direction as either one of the two image directions or none by the sign of the product of the two gradient values for each of the plurality of selected pixels.

11. The apparatus of claim 10, wherein the two image directions are orthogonal to each other.

12. The apparatus of claim 10, wherein the two image directions are two diagonal image directions.

13. A method for determining an edge trend for an interested pixel of an image, comprising the steps of:
obtaining two gradient values from a plurality of corresponding color values in two image directions for the interested pixel;
obtaining a difference between the two gradient values;
comparing the difference with a threshold, wherein if the difference is smaller than the threshold, the method further comprises the steps of:
evaluating a plurality of selected pixels nearby the interested pixel for obtaining a dominant image direction thereof; and
obtaining the edge trend from the dominant image direction.

14. The method of claim 13, wherein the two image directions are orthogonal to each other.

15. The method of claim 13, wherein the two image directions are a horizontal image direction and a vertical image direction.

16. The method of claim 13, wherein the step of evaluating a plurality of selected pixels nearby the interested pixel for obtaining a dominant image direction thereof comprises the steps of:
determining an image direction for each of the plurality of selected pixels;
obtaining a pixel number for each of the plurality of image directions by counting the plurality of selected pixels; and
determining the dominant image direction as the one of the plurality of image directions corresponding to the maximum of the plurality of pixel numbers.

17. The method of claim 16, wherein the plurality of image directions comprises a horizontal image direction or a vertical image direction.

18. The method of claim 16, wherein the step of determining an image direction for each of the plurality of selected pixels comprises the steps of:
obtaining two second gradient values from a second plurality of corresponding color values in two second image directions for each of the plurality of selected pixels; and
determining the image direction as either one of the two second image directions or none by the sign of the product of the two second gradient values for each of the plurality of selected pixels.

19. The method of claim 18, wherein the two second image directions are orthogonal to each other.

20. The method of claim 18, wherein the two second image directions are two diagonal image directions.

21. An apparatus for determining an edge trend for an interested pixel of an image, comprising:
a buffer for storing a plurality of color values of a plurality of selected pixels nearby the interested pixel; and
a processor for obtaining two gradient values from a plurality of corresponding color values among the plurality of color values in two image directions for the interested pixel, obtaining a difference between the two gradient values, and comparing the difference with a threshold;
wherein if the difference is smaller than the threshold, the processor further evaluates the plurality of selected pixels for obtaining a dominant image direction thereof, and obtains the edge trend from the dominant image direction.

22. The apparatus of claim 21, wherein the two image directions are a horizontal image direction and a vertical image direction.

23. The apparatus of claim 21, wherein the processor determines an image direction for each of the plurality of selected pixels, obtains a pixel number for each of the plurality of image directions by counting the plurality of selected pixels, and determines the dominant image direction as the one of the plurality of image directions corresponding to the maximum of the plurality of pixel numbers.

24. The apparatus of claim 23, wherein the plurality of image directions comprises a horizontal image direction or a vertical image direction.

25. The apparatus of claim 23, wherein the processor obtains two second gradient values from a second plurality of corresponding color values among the plurality of color values in two second image directions for each of the plurality of selected pixels, and determines the image direction as either one of the two second image directions or none by the sign of the product of the two second gradient values for each of the plurality of selected pixels.

26. The apparatus of claim 25, wherein the two second image directions are orthogonal to each other.

27. The apparatus of claim 25, wherein the two image directions are two diagonal image directions.
